(19) United States
(12) Patent Application Publication
(10) Pub. No.: US 2014/0156561 A1
(43) Pub. Date: Jun. 5, 2014

(54) METHOD OF SECURITY SCREENING AND SECURITY TRAY FOR USE THEREWITH

(71) Applicants: Ressa Gayle Steele, Vancouver (CA); Douglas Albert Ross, Richmond (CA); Garry Allen Brimson, Vancouver (CA)

(72) Inventors: Ressa Gayle Steele, Vancouver (CA); Douglas Albert Ross, Richmond (CA); Garry Allen Brimson, Vancouver (CA)

(73) Assignees: STEELHEAD SECURITY INC., Vancouver, BC (CA); Steelhead Security Inc., Vancouver (CA)

(21) Appl. No.: 14/004,491

(22) PCT Filed: Mar. 15, 2012
(86) PCT No.: PCT/CA12/00309

§ 371 Date: Oct. 4, 2013

Related U.S. Application Data
(60) Provisional application No. 61/453,027, filed on Mar. 15, 2011.

(51) Int. Cl. B65D 1/36; G06Q 90/00

(52) U.S. Cl. CPC B65D 1/36; G06Q 90/00
USPC 705/500; 206/459.5

(57) ABSTRACT

A method for allowing security personnel in screening stations to more quickly identify prohibited articles and to identify and interrogate the screened individual responsible for the prohibited article, thereby improving throughput and reducing human error. If an operator observes articles which raise a security concern, the operator isolates the location of such articles by referencing the compartment in the tray where it is located and optionally whether the article is in a high or low position in the compartment and by referencing a tray's unique identifier. A security tray design is provided to carry out the method which includes discrete delineated compartments, and optionally a unique identifier and an area for displaying the screened individual's identification to connect the individual to a unique tray, to assist in preventing individuals from gaining access to restricted areas with prohibited articles.

### CROSS REFERENCE TO RELATED APPLICATION

The present application claims the benefits, under 35 U.S.C.§119(e), of U.S. Provisional Application Ser. No. 61/453,027 filed Mar. 15, 2011 entitled “Method of Security Screening and Security Tray for Use Therewith” which is incorporated herein by this reference.

### TECHNICAL FIELD

The invention relates to the field of security screening and methods and apparatus for use therewith.

### BACKGROUND

Increased security concerns arising from increasing numbers of violent attacks on civilians in public places, whether by organized terrorist groups or individuals, has necessitated the increasing use of security screening facilities at points of access to public places, particularly in airports but also in other public buildings such as courthouses or legislative buildings or at public events. Generally such facilities include a metal detector through which the individual passes, possibly a full-body scanner and an X-ray machine provided with a conveyor for scanning closed baggage, jackets etc. and possibly explosives trace detection machines, or “puffer” machines. At present the articles to be scanned are placed in simple plastic trays placed on the conveyor. A problem with current security clearance trays is that items are placed and arranged in the trays in disorganized and overlapping fashion, and since multiple trays will be moving on a conveyor at any given time, there may be confusion with the operator as to which of the trays being scanned contains potentially problematic material and where on the tray the material is located when the tray is removed from the scanner.

The foregoing examples of the related art and limitations related thereto are intended to be illustrative and not exclusive. Other limitations of the related art will become apparent to those of skill in the art upon a reading of the specification and a study of the drawings.

### SUMMARY

The following embodiments and aspects thereof are described and illustrated in conjunction with systems, tools and methods which are meant to be exemplary and illustrative, not limiting in scope. In various embodiments, one or more of the above-described problems have been reduced or eliminated, while other embodiments are directed to other improvements.

The invention provides a method for allowing security personnel in screening stations to more quickly identify prohibited articles and to identify and interrogate the screened individual responsible for the prohibited article, thereby improving throughput and reducing human error. If an operator observes articles which raise a security concern, the operator isolates the location of such articles by referencing the compartment in the tray where it is located and optionally by referencing whether the article is in a high or low position in the compartment and by referencing the tray's unique identifier. A security tray design is provided to carry out the method which includes discrete delineated compartments, and optionally a unique identifier and an area for displaying the screened individual's identification to connect the individual to a unique tray, to assist in preventing individuals from gaining access to restricted areas with prohibited articles.

In addition to the exemplary aspects and embodiments described above, further aspects and embodiments will become apparent by reference to the drawings and by study of the following detailed descriptions.

### BRIEF DESCRIPTION OF DRAWINGS

Exemplary embodiments are illustrated in referenced figures of the drawings. It is intended that the embodiments and figures disclosed herein are to be considered illustrative rather than restrictive.

FIG. 1 is a schematic diagram, in plan view, of a security screening station for implementing the invention;

FIG. 2 is a top right front perspective view of a security tray according to the invention;

FIG. 3 is a top right front perspective view of two security trays as shown in FIG. 1 in stacked configuration;

FIG. 4 is a top left perspective view of a security tray as shown in FIG. 1;

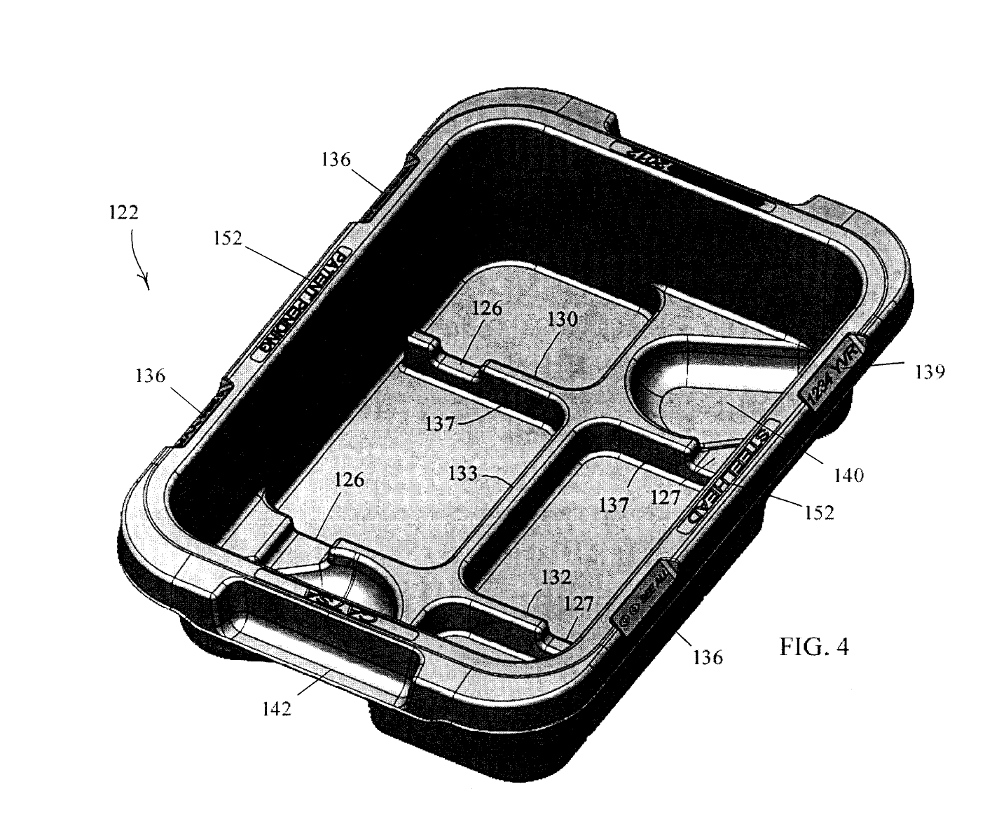

FIG. 5 is a top front perspective view of a security tray according to the invention;

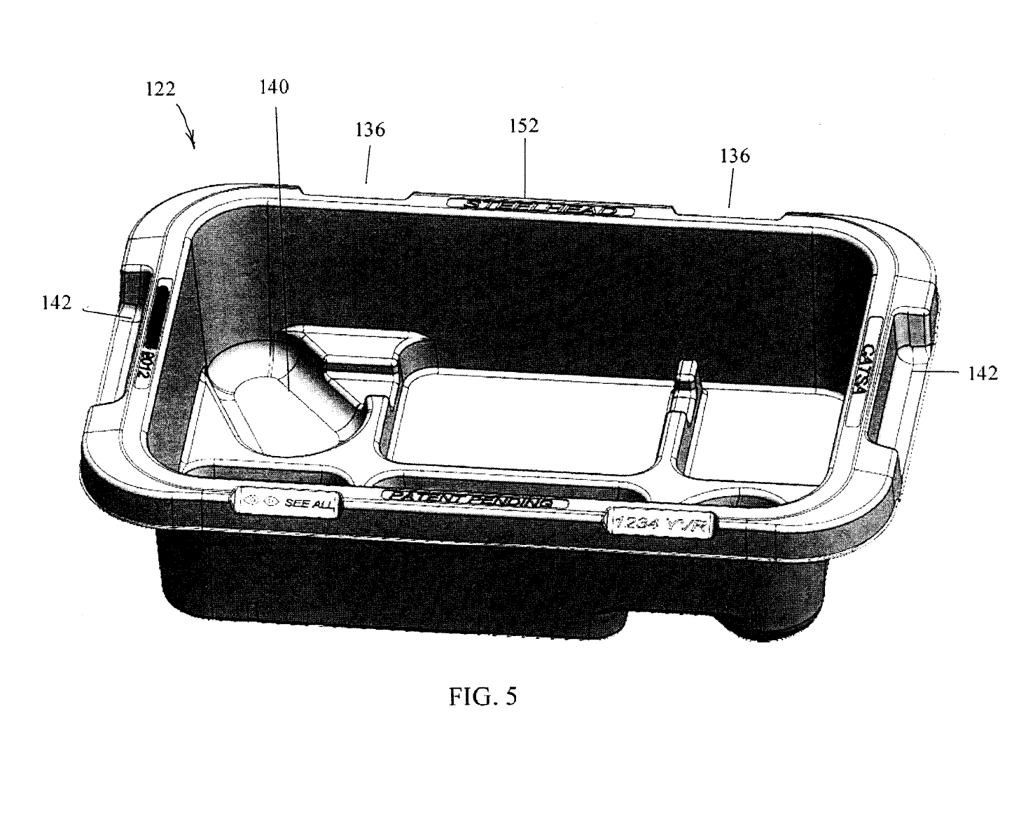

FIG. 6 is a top plan view of the security tray shown in FIG. 1;

FIG. 7 is a bottom plan view of the security tray shown in FIG. 1;

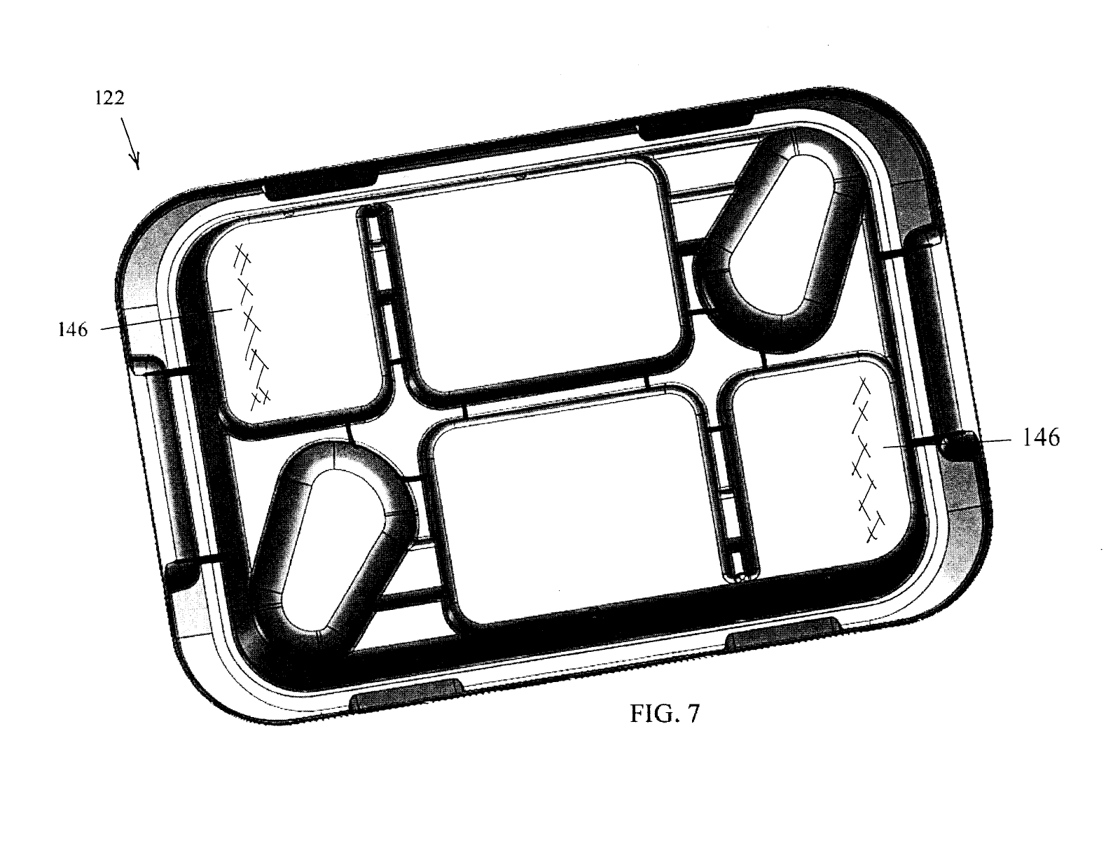

FIG. 8 is a front elevation view of the security tray shown in FIG. 1, the rear elevation view being identical;

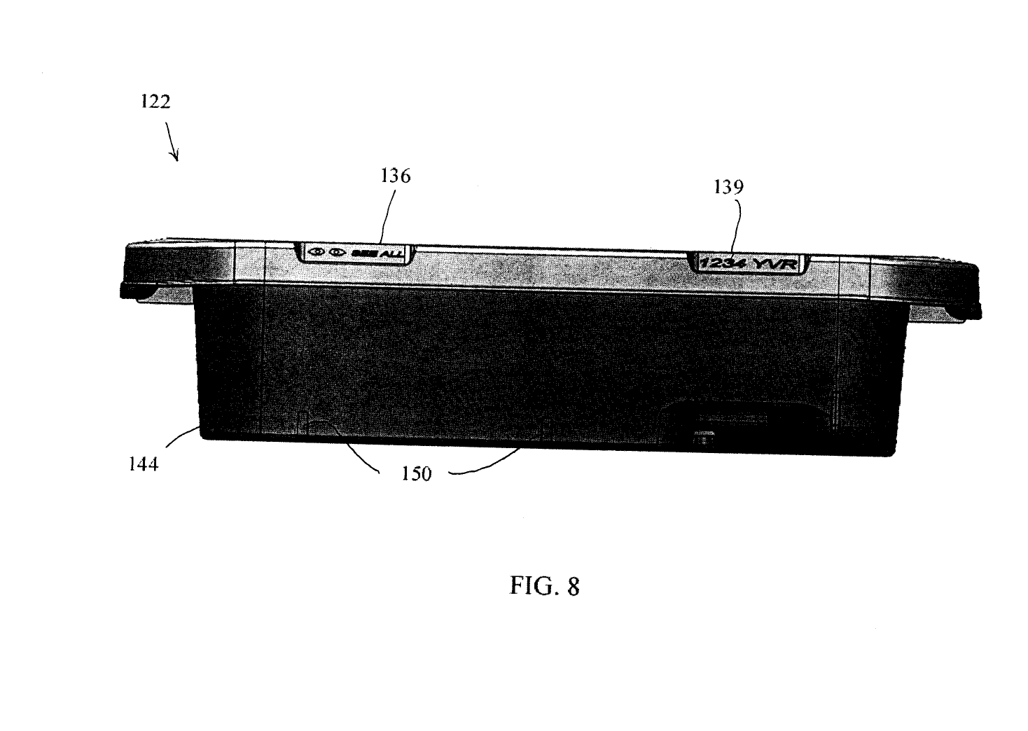

FIG. 9 is a right side elevation view of the security tray shown in FIG. 1, the left side elevation view being identical thereto;

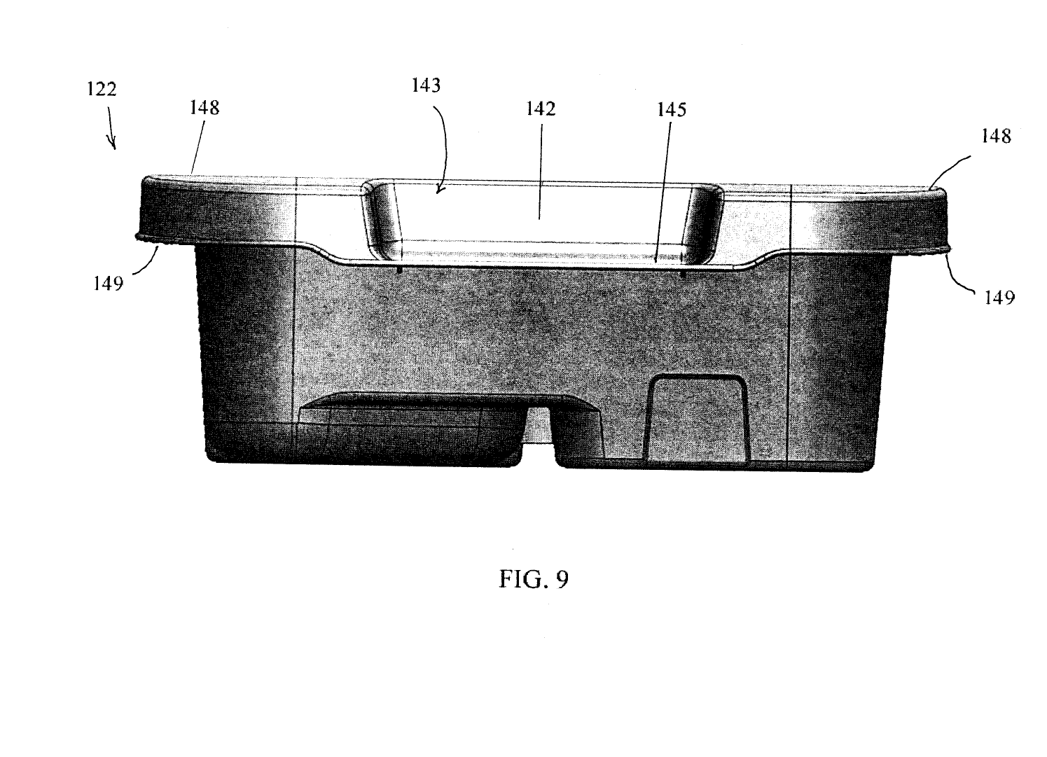

FIG. 10 is a top right front perspective view of a security tray illustrating its appearance made of transparent material.

### DESCRIPTION

Throughout the following description specific details are set forth in order to provide a more thorough understanding to persons skilled in the art. However, well known elements may not have been shown or described in detail to avoid unnecessarily obscuring the disclosure. Accordingly, the description and drawings are to be regarded in an illustrative, rather than a restrictive, sense.

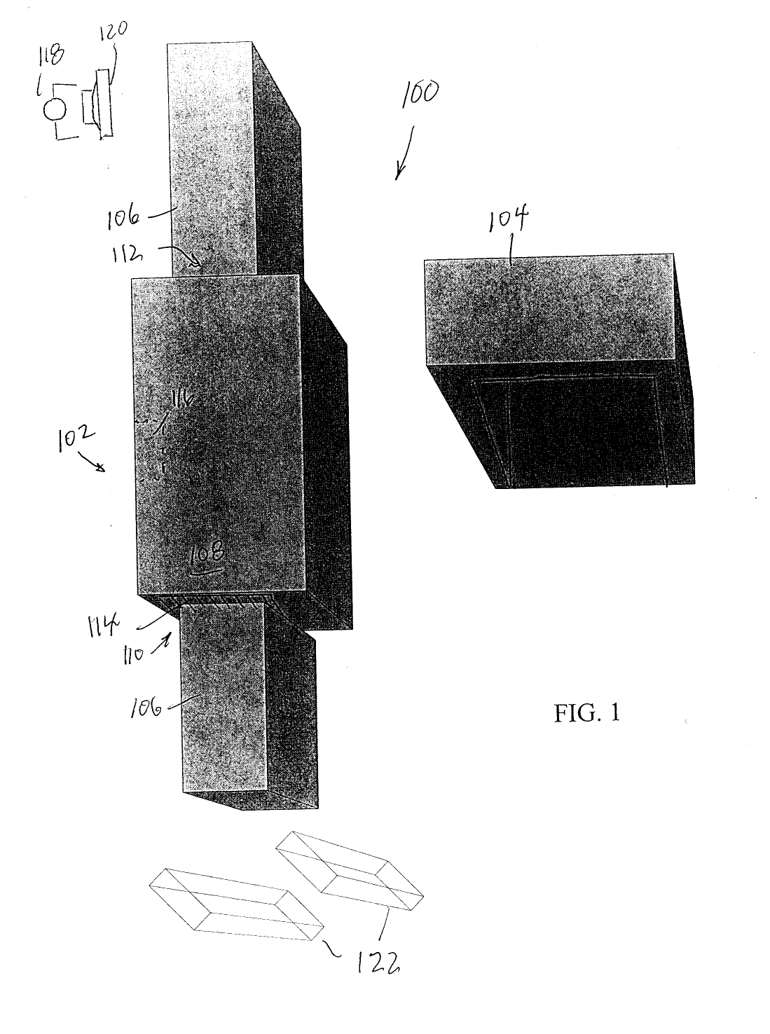

With reference to FIG. 1, a security screening station 100 includes a scanning station 102 and a metal detector 104. Scanning station 102 includes a conveyor 106, housing 108 with entry 110 and exit 112, lead curtain 114 covering the entry and exit to prevent egress of x-rays from the scanner, and an x-ray scanner 116. An operator 118 observes the scanned image on display screen 120. A plurality of security trays 122 are provided to receive articles from the individuals being screened for transport through the scanning station 102. While the individual proceeds through the metal detector 104, the tray or trays 122 carrying the individual's personal articles are placed on conveyor 106 and proceed through housing 108 where the articles are scanned and scanner operator 118 observes the scanned images to determine if any of the articles are prohibited items or otherwise are a concern, such as liquids, weapons, sharp objects, explosives etc.

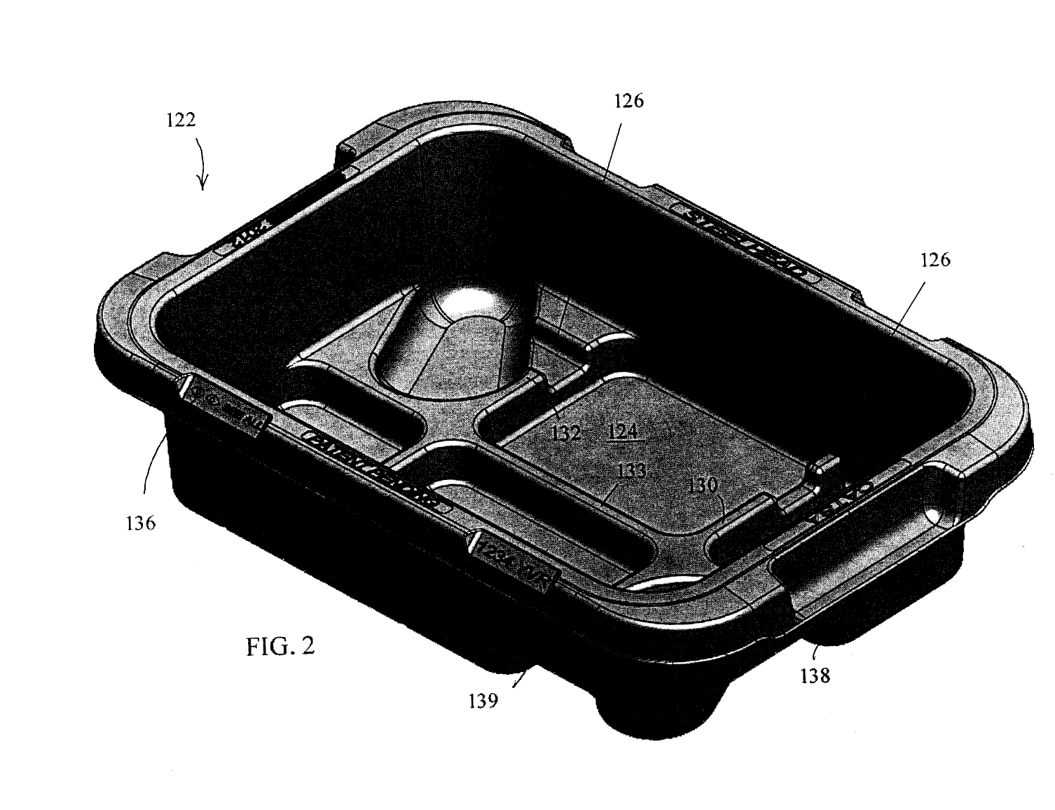

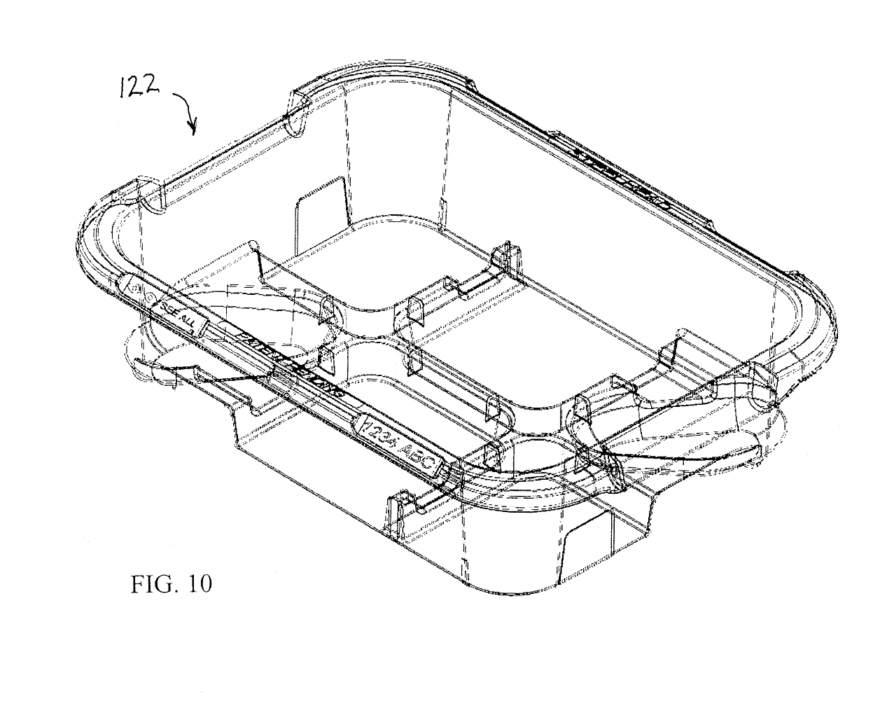

With reference to FIG. 2, tray 122, shown in shading for better illustration, is preferably formed or molded of a transparent plastic (as illustrated in FIG. 10) to assist the visual identification of scanned items, and to reduce the possibility that items may be accidentally left in the tray by the screened person. The base 124 of tray 122 is compartmentalized to aid the distribution and separation of articles such as electronics, composite metals and liquids. Compartmentalized base 124 reduces the overlapping of objects to allow faster and more accurate identification of objects by the operator. The provision of compartments also allows the operator to identify targets to the security personnel using the unique tray identification described below, and the location of the compartment thus improving throughput.

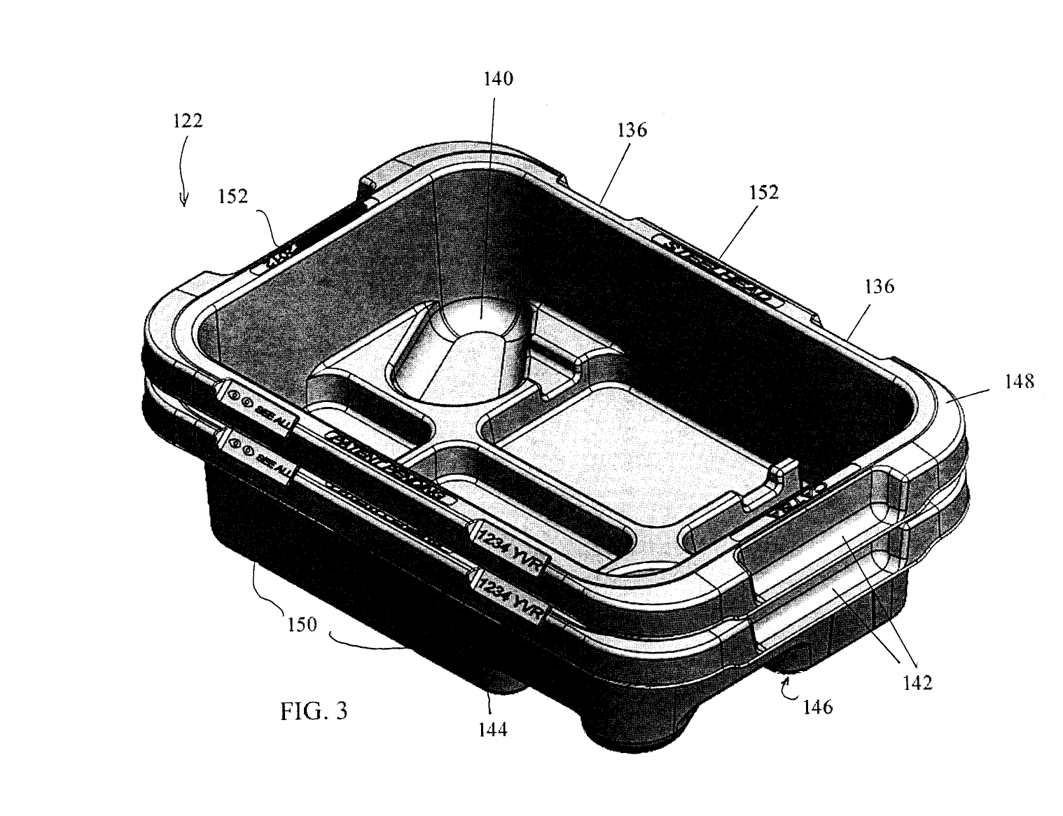

The compartmentalized base design of tray 122 is preferably mirrored so it can be stacked in either direction (see FIG. 3).

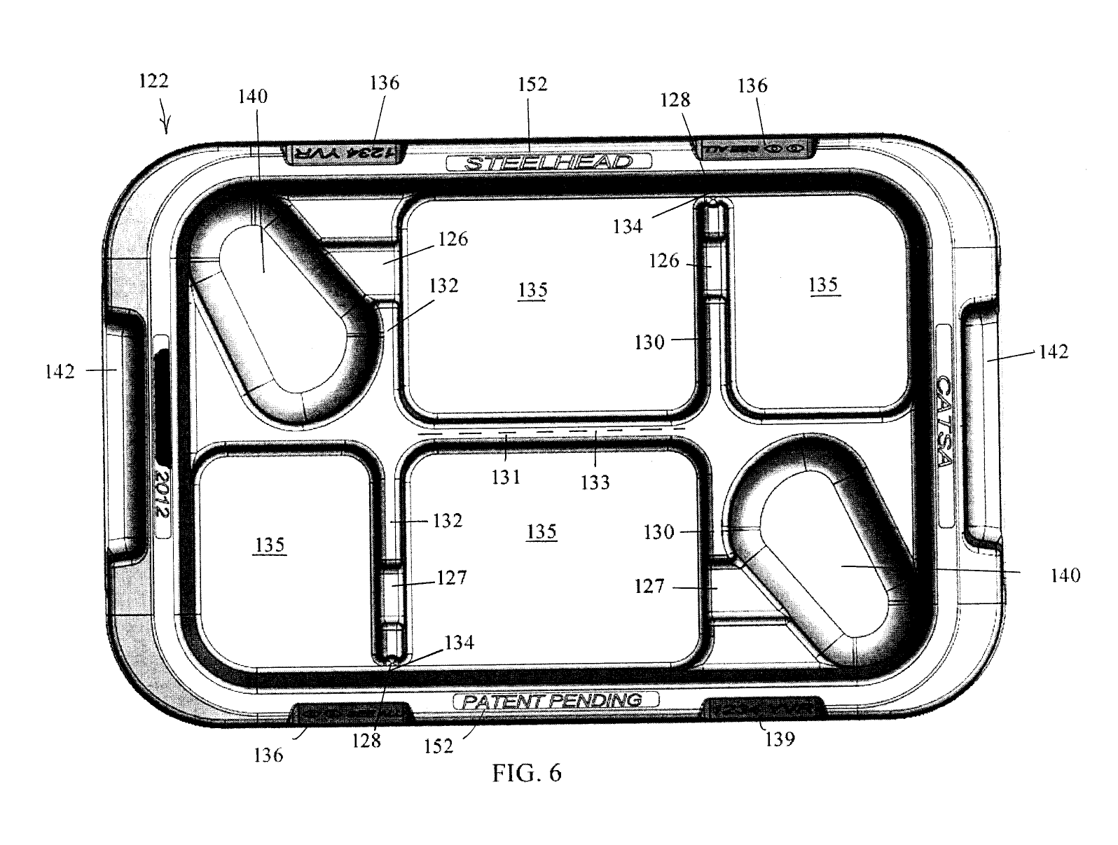

The upstanding lateral ridges 130 and 132 and longitudinal ridge 133 which form the compartments 135 (FIG. 6) also improve the strength and stability of the tray when carrying heavy objects. Two axis scanning slots 126, 127 are provided on each of lateral ridges 130, 132, located and sized to allow a laptop, notebook or tablet PCs to rest vertically against the side of the tray rather than lying below or on top of other articles to aid two axis scanning and prevent overlapping. A laptop can also be opened with edges resting in each of the two slots 126, 127 to ensure it remains vertically oriented.

The outer vertical surface of the ends of ridges 130, 132 is shaped to form a vertical depression 128, C-shaped in horizontal cross-section, so it can receive the spine of a passport standing in slot 134. Slot 134 can also receive a boarding pass. This facilitates reading of the identification by the security personnel and/or automatic reading equipment which may be combined with the scanned (x-ray) image and/or stored for future retrieval.

In order to better define compartments 135 for the operator, it is preferred that markers 131 which are at least partially radio-opaque, such as metal strips can be provided on the top or upper surface of each of the ridges 130, 132 and 133, whether above, underneath or embedded within the surface. Other forms of fully or partially radio-opaque delineators can be applied to or embedded in the tray's inner surface, or the tray material itself may be sufficiently radio-opaque to permit the operator to view the compartment dividers. This will assist the operator in defining the compartments to communicate to the security personnel. Depending on the material from which the trays are manufactured, for example the operator of the scanning station may be able to delineate the compartments simply by the location of the ridges 130, 132 and 133, or by other fully or partially radio-opaque features of the tray's inner surfaces.

One or more additional partially or fully radio-opaque markers 137 can also be provided to allow the personnel to identify the depth of the article in the compartment 135 by reference to the level of the marker. Such markers 137 may be as metal strips can be provided on the top or upper surface of each of the ridges 130, 132 and 133, whether above, underneath or embedded within the surface. Again depending on the material from which the trays are manufactured, the operator of the scanning station may be able to delineate the depth of the article in the compartment 135 simply by the location of ridges or other fully or partially radio-opaque features of the tray's inner surfaces.

A plurality of 45 degree display panels 136 are provided to which are affixed a unique identifier 139 to uniquely identify the tray, such as alphanumeric characters which are at least partially radio-opaque and so which can be read by x-ray, for example YVR 1234, LAX 9012, LHR 5678 etc. or a barcode or other visible or electronic code such as an RFID chip. The identifier 139 may be on the surface of the panel 136 or embedded. By making the panel sloped to the vertical or horizontal, such as preferably approximately 45 degrees to vertical but as much as 60 degrees, it can be scanned from either the vertical or horizontal plane. By placing it below the level of the rim of the tray 122, wear on the identifying label on panel 136 reduced. The location of the display panel permits the security personnel to associate the tray number with the screened person's identification papers located in slot 134. As an additional or alternate means of uniquely identifying tray 122, it may be provided with an RFID chip in another location which can be affixed by adhesive, for example in a depression at a location 138.

Ergonomically designed coin scoops are provided at 140 so that coins and other small objects and/or watches and jewellery can be quickly and easily retrieved from the tray. The design shown allows either left or right handed individuals equal access to the scoops 140. By isolating the coins in such scoops the movement of the coins during the process is reduced and throughput is increased since individuals are able to retrieve the items more quickly. Handles 142 are ergonomically formed in tray 122 with beaded edges 145 to reduce wear on gloves. The vertical face 143 of the tray formed by the handles 142 can provide an additional message area, as can the area below the handles.

Preferably the body of tray 122 is formed of a soft plastic to reduce noise, reduce scratches and be comfortable for the hands of users. A translucent and/or textured band may be provided around the base of the tray at 144 to improve the appearance in that area which is prone to scratches or scuffing. Bands of grip or textured material, or pinpoint grip features may be provided along the base at 146 to allow greater grip on the tray by the conveyor, to assist it in passing through the curtain 114. The lip of the tray 148 has rounded ends and beaded edges 149 to prevent catching on curtain 114 and improve comfort of handling. An overmolding process can be used to provide a softer or more easily gripped surface on grips 142, or to provide a second material layer for other tabs or attachments. Where a clear plastic piece is used to overmold the grip, a label, logo, country identifier such as a flag or the like can be applied to the surface of the grips before the overmolding layer is applied.

Tray 122 may be provided with thinner areas such as tabs or punch-out holes 150 which can be readily punched out to form apertures through which air blown chemical or particle trace detection (“sniffing”) can be conducted. These apertures may be supplied to the user already punched out, as a hole or slot. Embossed message areas 152 can also be provided on the lip 148 of the tray to provide security messages or company branding. One possible security image which can be embossed or molded in the tray at 152 is an image of a pair of eyes, which has been found to reduce dishonest behavior.

In operation the screened individual enters the security screening station 100 and obtains tray 122 at the scanning station 102. The individual places coins, laptop, metal articles, cell phone etc. in the appropriate or any section or compartment of tray 122 and proceeds through metal detector 104. Security personnel place tray 122 on conveyor 106 which carries it into housing 108 where the operator observes the X-ray scan of the contents of tray 122. If operator 118 observes articles which raise a security concern, such as liquids, weapons, sharp objects, explosives etc. the operator isolates the location of such articles by referencing the tray's unique identifier on display panel 136, and the compartment where it is located (e.g. right center, left corner, or by any other pre-arranged means of identifying a compartment and/or level, e.g. a-f/ high, 1-6/ low etc.). In this way the security personnel can more quickly inspect the offending article, identify the screened individual's identification by passport or boarding pass and interrogate the screened individual thereby improving throughput and reducing human error.

To increase its product life, the security tray is preferably made of a transparent material which is resistant to repeated X-ray exposure, such as clarified polypropylene. It may also be desirable to provide for sterilization of the trays periodically. This may be doe as part of the in-line procedure during the scanning process or by a separate batch process.

Sterilization may be done by ultra-violet light, heat or chemicals. The use of a clear polypropylene material for the security tray is appropriate for sterilization by heat and/or chemicals. For sterilization by ultra-violet light, since UVC light (wavelength from about 100 to 280 nm) is most effective for sterilization the preferred material for the security tray in that embodiment is a polymer which is substantially transparent to UVC light.

While a number of exemplary aspects and embodiments have been discussed above, those of skill in the art will recognize certain modifications, permutations, additions and sub-combinations thereof. It is therefore intended that the invention be interpreted to include all such modifications, permutations, additions and sub-combinations as are within their true spirit and scope.

What is claimed is:

1. A method of security screening of individuals wherein said individuals' articles to be screened are deposited in a security tray which carries said articles through a scanning station comprising an x-ray scanner and an operator of said scanning station, said method comprising:
i) providing in said security tray compartments for receiving said articles which are delineated by indicators which are at least partially opaque to x-rays; and
wherein when an operator observes an article in a security tray which raises a security concern, the operator isolates the location of said article by referencing the compartment in the tray where it is located to thereby permit security personnel in said screening station to inspect said article and to identify and interrogate the screened individual responsible for said article.

2. The method of claim 1 wherein said security tray further comprises indicators which are at least partially opaque to x-rays and which delineate whether said article is in a high or low position in the compartment, and said method further comprises the step of:
ii) when an operator observes an article in a security tray which raises a security concern, the operator further isolating the location of said article by referencing whether said article is in a high or low position in the compartment in the tray where it is located.

3. The method of claim 1 or 2 further comprising the steps of:
iii) providing each security tray with a unique identifier; and
iv) associating each said individual with the unique identifier of the tray into which said individual's articles are deposited for scanning;
whereby when an operator observes an article in a security tray which raise a security concern, the operator isolates the location of said article by referencing the tray's unique identifier and the compartment in the tray where it is located to thereby permit security personnel in said screening station to inspect said article and to identify and interrogate the screened individual responsible for said article.

4. The method of claim 3 wherein said unique identifier is selected from the group consisting of radio-opaque alphanumeric characters, barcode, electronic code and RFID chip.

5. The method of claims 1 to 4 wherein said tray is made of transparent material.

6. The method of claims 1 to 5 wherein said security tray further comprises an area for holding and displaying a screened individual's unique identification documents, said method further comprising the step of said security personnel in said screening station observing said screened individual's unique identification documents to identify and interrogate the screened individual responsible for said article.

7. A security tray for use in security screening of individuals wherein said individuals' articles to be screened are deposited in said security tray which carries said articles through a scanning station comprising an x-ray scanner and an operator of said scanning station, said security tray comprising:
i) a horizontally extending base having an upper surface and a lower surface;
ii) vertically extending walls extending upwardly from the perimeter of said base thereby forming an article receiving area defined by said vertically extending walls;
iii) a plurality of compartments formed in said article receiving area for receiving said articles, wherein said compartments are delineated by indicators which are at least partially opaque to x-rays; and
iv) one or more indicators which are at least partially opaque to x-rays and which distinguish between a high or low position in each said compartment.

8. The security tray of claim 7 further comprising:
v) a unique identifier.

9. The security tray of claim 8 wherein said unique identifier is selected from the group consisting of alphanumeric characters which are at least partially radio-opaque, barcode, electronic code and RFID chip.

10. The security tray of claims 7 to 9 wherein said security tray is manufactured from transparent material.

11. The security tray of claims 7 to 10 further comprising an area for holding and displaying a screened individual's unique identification documents to connect the individual to a unique tray.

12. The security tray of claims 7 to 11 wherein said compartments are formed by upstanding lateral and longitudinal ridges in the upper surface of said base.

13. The security tray of claim 12 wherein axis scanning slots to aid two axis scanning and prevent overlapping are formed on one or more of said lateral ridges to allow a computer or other item to rest in a substantially vertically extending position rather than lying horizontally below or on top of other articles.

14. The security tray of claim 12 or 13 wherein said area for holding and displaying a screened individual's unique identification documents comprises a vertical depression formed in the outer vertical surface of the ends of said lateral ridges, being thereby adapted to receive the spine of a passport or a boarding pass.

15. The security tray of claims 12 to 14 wherein said at least partially radio-opaque indicators which delineate compartments are metal strips provided on the top or upper surface of said lateral or longitudinal ridges or embedded within such surfaces, or physical features of the interior surface of said security tray.

16. The security tray of claim 7 wherein said indicators which are at least partially opaque to x-rays and which distinguish between a high or low position in each said compartment are metal strips provided on surfaces of the interior of said security tray or are embedded within such surfaces, or are physical features of the interior surface of said security tray.

17. The security tray of claims 8 to 16 wherein said unique identifier is located on a panel sloped to the vertical or horizontal, at a slope of between 45 degrees and 60 degrees to vertical.

18. The security tray of claims 7 to 17 wherein said security tray is made of X-ray resistant material.

19. The security tray of claims 7 to 18 wherein said security tray is made of clarified polypropylene.

20. The security tray of claims 7 to 19 wherein said security tray is made of a polymer which is substantially transparent to UVC light.

21. The security tray of claims 7 to 20 wherein said security tray is provided with portions of reduced thickness adapted to be punched out to form apertures through which chemical or particle trace detection can be conducted.

22. The security tray of claims 7 to 21 comprising a compartment adapted for receiving small articles such as coins or jewelry by being provided with a smoothly scooped surface.

23. The security tray of claims 7 to 22 comprising rounded leading and trailing surfaces and edges having rounded or beaded corners to prevent catching on scanner curtains.
